(19) United States
(12) Patent Application Publication
(10) Pub. No.: US 2026/0016384 A1
(43) Pub. Date: Jan. 15, 2026

(54) TESTING METHOD FOR YOUNG'S MODULUS AND POISSON'S RATIO BASED ON SQUARE PLATE

(71) Applicant: Kunming University, Kunming (CN)

(72) Inventors: Wenbin Zhang, Kunming (CN); Longxin Zhang, Kunming (CN); Yan Li, Kunming (CN); Yaxing Ma, Kunming (CN); Han Xu, Kunming (CN); Panpan Guo, Kunming (CN); Chunlin Zhao, Kunming (CN); Zhipeng Yin, Kunming (CN)

(21) Appl. No.: 18/819,386

(22) Filed: Aug. 29, 2024

(30) Foreign Application Priority Data
Jul. 9, 2024 (CN) 202410910255.5

(51) Int. Cl. G01N 3/30

(52) U.S. Cl. CPC G01N 3/30; G01N 2203/0075; G01N 2203/0282; G01N 2203/0658; G01N 2203/0688

(57) ABSTRACT

A testing method for Young's modulus and Poisson's ratio based on a square plate is provided, which including: obtaining a height, a length, a density, and a quality information of the square plate specimen; measuring the first-order torsional frequencie and the second-order torsional frequencie of the square plate specimen; calculating Poisson's ratio based on the height, the length, the first-order torsional frequency, and the second-order torsional frequency of the square plate specimen; calculating the Young's modulus of the square plate specimen based on the Poisson's ratio and the density. The method establishes a continuous function relationship between the parameter set of the test specimen and the torsional frequency using homotopy method, which can be used to calculate Poisson's ratio. When the material density and Poisson's ratio are known, the Young's modulus can be calculated in conjunction with ANSYS software. The method has advantages in both testing efficiency and accuracy.

### CROSS-REFERENCE TO RELATED APPLICATIONS

This application claims to the benefit of priority from Chinese Application No. 202410910255.5 with a filing date of Jul. 9, 2024. The content of the aforementioned applications, including any intervening amendments thereto, are incorporated herein by reference.

### TECHNICAL FIELD

The present disclosure relates to the technical field of physical quantity measurement, in particular to a testing method for Young's modulus and Poisson's ratio based on a square plate.

### BACKGROUND

Young's modulus, also known as tensile modulus, is used to describe the ability of a solid material to resist deformation, and is an important parameter in material mechanics. The Young's modulus has important application value in many fields, including metal material performance testing, biomedical research, material engineering, material science, geology, and mechanical engineering. For example, in the biomedical field, Young's modulus can be used to evaluate the health status or the extent of lesions of biological tissues; in material engineering, Young's modulus is an important parameter for evaluating material performance, which helps engineers choose appropriate materials. Therefore, calculating Young's modulus is important for understanding material performance, material selection, and for engineering design and analysis.

Poisson's ratio is an important dimensionless parameter in material mechanics, which reflects the proportional relationship between the transverse deformation and longitudinal deformation of a material under uniaxial tension or compression. It has a wide range of applications in material science, engineering, physics, and other fields, and is one of the important indicators for describing material properties.

However, the calculation methods for Young's modulus and Poisson's ratio have encountered technical bottlenecks in recent years, and their research development has been relatively slow. The main problems currently exist are that the measurement is not convenient and fast enough, and traditional calculation methods are difficult to consider the influence of the material, resulting in insufficient calculation accuracy.

### SUMMARY

In view of this, the present disclosure provides a testing method for Young's modulus and Poisson's ratio based on a square plate to improve the convenience and accuracy of Young's modulus measurement.

To achieve the above objective, the present disclosure provides a testing method for Young's modulus and Poisson's ratio based on a square plate, including the following steps:

Obtaining a height, a length, a density, and a quality information of the square plate specimen;

Measuring a first-order torsional frequency and a second-order torsional frequency of the square plate specimen;

Obtaining a relationship between the first-order torsional frequency, the second-order torsional frequency, and an ideal first-order torsional frequency, an ideal second-order torsional frequency based on an influence of system damping;

Calculating Poisson's ratio based on the height, the length, the first-order torsional frequency, and the second-order torsional frequency of the square plate specimen;

Calculating a Young's modulus of the square plate specimen based on the Poisson's ratio and the density.

Optionally, the relationship between the first-order torsional frequency, the second-order torsional frequency, the ideal first-order torsional frequency, and the ideal second-order torsional frequency is as follows:

$${\overline{f}}_{7} = \sqrt{1 - {ζ}_{7}^{2}} {f}_{7} ,$$

$${\overline{f}}_{8} = \sqrt{1 - {ζ}_{8}^{2}} {f}_{8} ,$$

In the formula, ξ₇, ξ₈ represents the modal damping ratio; f₇ is the first-order torsional frequency, f₈ is the second-order torsional frequency, and f̅₇ and f̅₈ are the ideal first-order torsional frequency and the ideal second-order torsional frequency, respectively.

Optionally, the calculation process of Poisson's ratio includes:

Calculating a frequency ratio between the first-order torsional frequency and the second-order torsional frequency;

Calculating a thickness-length ratio of the square plate specimen;

Constructing a continuous function relationship between the frequency ratio and the Poisson's ratio of the square plate specimen;

Calculating Poisson's ratio through homotopy method based on the continuous function relationship.

Optionally, the continuous function relationship is as follows:

$$\frac{{f}_{8}}{{f}_{7}} = {ψ}_{\frac{8}{7}} ( μ , \frac{h}{l} )$$

wherein, f₈ is the second-order torsional frequency of the square plate specimen, f₇ is the first-order torsional frequency, h is the height, and l is the length.

Optionally, the thickness-length ratio is fixed at 0.001 and 0.1, the continuous function relationship is:

$${ψ}_{\frac{8}{7}} ( μ , 0.001 ) = 0.0303331630728725 {μ}^{2} + 0.12783046900851 μ + 1.41427221610838 ;$$

$${ψ}_{\frac{8}{7}} ( μ , 0.1 ) = 0.010193216028756 {μ}^{2} + 0.162230099055876 μ + 1.44015288291539 .$$

Optionally, a process of calculating the Poisson's ratio through homotopy method includes:

Introducing parameters into the continuous function relationship through homotopy method, constructing a continuous function relationship between the frequency ratio and the thickness-length ratio and Poisson's ratio of the square plate specimen, and calculating Poisson's ratios of different isotropic materials based on the continuous function relationship.

Optionally, the parameter introduced to the continuous function relationship through homotopy method is shown in the following formula:

$$p ( \frac{h}{l} ) = - 59.6865121095568 {( \frac{h}{l} )}^{2} + 16.2937683627739 \frac{h}{l} - 0.0288130972097893$$

Optionally, the calculation of Poisson's ratio is as follows:

$$\frac{{\overline{f}}_{8}}{{\overline{f}}_{7}} == \sqrt{\frac{1 - {ζ}_{8}^{2}}{1 - {ζ}_{7}^{2}}} φ ( μ , p ) ,$$

wherein, ξ₇ and ξ₈ respectively represent a seventh-order modal damping and an eighth-order modal damping corresponding to f̅₇, f̅₈ of the square plate specimen.

Optionally, the continuous function relationship is as follows:

$$φ ( μ , p ) = ( 1 - p ) + p {ψ}_{\frac{8}{7}} ( μ , 0.1 )$$

wherein, p is an introduced homotopy parameter.

Optionally, the modal damping is as follows:

$${ζ}_{i} = \frac{c}{\sqrt{{k}_{i} {m}_{i}}} \approx \frac{ln \frac{x ( t )}{x ( t + {NT}_{d} )}}{2 N π}$$

wherein, ξᵢ represents the modal damping, kᵢ and mᵢ respectively represent element stiffness and element quality, c represents damping coefficient, x(t) represents damping vibration signal, N represents the number of periods, T_{d} represents the period of quasi-periodic motion in the presence of damping.

Compared with the existing technology, the advantageous effects of the present disclosure are:

The present disclosure does not require adjusting the support position, all elastic parameters of the same specimen can be obtained in one experiment, and the homotopy method is used to establish a continuous function relationship between the parameter set of the test specimen and the torsional frequency, which can be used to calculate Poisson's ratio. When the material density and Poisson's ratio are known, the Young's modulus can be calculated in conjunction with ANSYS software. Compared with traditional dynamic testing techniques, the method has advantages in both testing efficiency and accuracy. In the Poisson's ratio calculation process, the influence of damping on the test results is considered, further improving the calculation accuracy.

### BRIEF DESCRIPTION OF THE DRAWINGS

By reading the detailed description of the preferred embodiments in the following text, various other advantages and benefits will become clear to those skilled in the art. The accompanying drawings are only for the purpose of illustrating preferred embodiments and should not to be considered as limitations to the present disclosure. In the attached figure:

FIG. 1 is a schematic diagram of the testing method for Young's modulus and Poisson's ratio based on a square plate according to the present disclosure;

FIG. 2 is a schematic diagram of the relationship between sets and frequency ratios in the embodiment of the present disclosure;

FIG. 3 is a schematic diagram of the comparison effect between simulation data and homotopy method in the embodiment of the present disclosure;

FIG. 4 is a schematic diagram of the testing method in the embodiment of the present disclosure;

FIG. 5 is a schematic diagram of the testing steps in the embodiment of the present disclosure.

### DETAILED DESCRIPTION OF THE EMBODIMENTS

The exemplary embodiments of the present disclosure will be described in more detail below with reference to the accompanying drawings. Although exemplary embodiments of the present disclosure are shown in the accompanying drawings, it should be understood that the present disclosure may be implemented in various forms and should not be limited by the embodiments described herein. On the contrary, these embodiments are provided to enable a more thorough understanding of this disclosure and to fully convey the scope of the present disclosure to those skilled in the art. It should be noted that the embodiments and features in the embodiments of the present disclosure can be combined with each other without conflict. The present disclosure will be described in detail below with reference to the accompanying drawings and in conjunction with embodiments.

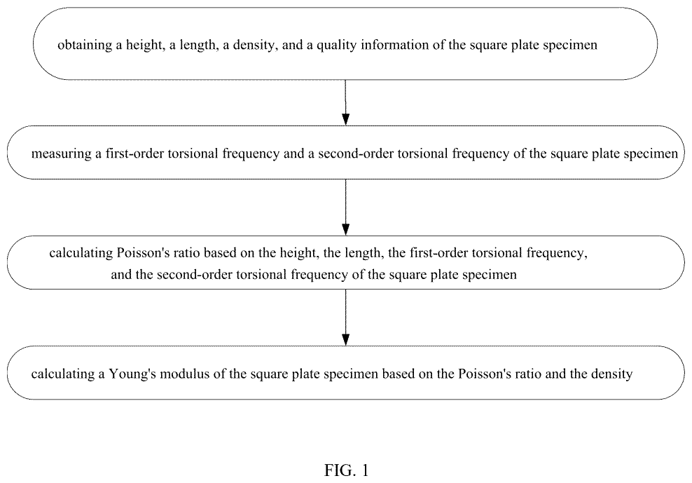

This embodiment proposes a testing method for Young's modulus and Poisson's ratio based on a square plate, as shown in FIG. 1, which includes:

The calculation of Poisson's ratio:

There exists the following functional relationship:

$$\frac{{f}_{8}}{{f}_{7}} = {ψ}_{\frac{8}{7}} ( μ , \frac{h}{l} ) \qquad ( 1 )$$

$${ψ}_{\frac{8}{7}} ( μ , \frac{h}{l} ) ,$$

as shown in FIG. 1.

From the figure, it can be seen that when h/l is less than 10%, the relationship from the set (μ,h/l) to the set

$$\frac{{f}_{8}}{{f}_{7}}$$

is a one-to-one mapping. Due to the fact that actual testing is usually done to save materials, h/l less than 10% is acceptable. When actually making specimens, h/l is usually not a rational number. In this embodiment, the homotopy method is used to introduce the parameter:

$$p ( \frac{h}{l} ) = - 60.410778449884 {( \frac{h}{l} )}^{2} + 163.263236949884 \frac{h}{l} - 0.0245424675384627 \qquad ( 2 )$$

Continuous change from the set

$$( μ , \frac{h}{l} )$$

to the set

$$\frac{{f}_{8}}{{f}_{7}} : φ ( μ , p ) = ( 1 - p ) {ψ}_{\frac{8}{7}} ( μ , 0.001 ) + p {ψ}_{\frac{8}{7}} ( μ , 0.1 ) \qquad ( 3 )$$

In the formula:

$${ψ}_{\frac{8}{7}} ( μ , 0.001 ) = 0.0303331630728725 {μ}^{2} + 0.127830469008510 μ + 1.414272216 \; 10838 \qquad ( 4 )$$

$${ψ}_{\frac{8}{7}} ( μ , 0.1 ) = 0.0101932160287526 {μ}^{2} + 0.162230099055876 μ + 1.44015288291539 \qquad ( 5 )$$

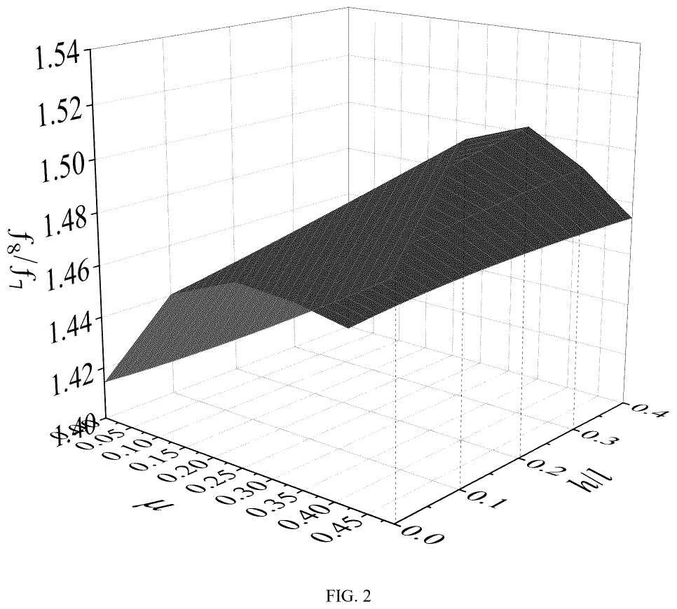

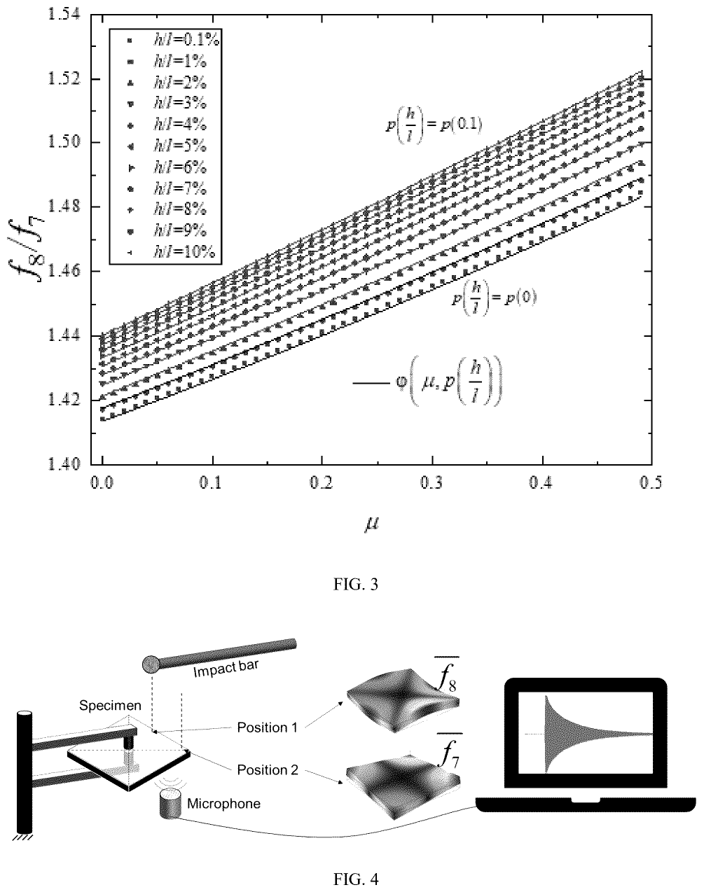

As shown in FIG. 2, the change relationship from the set

$$( μ , \frac{h}{l} )$$

to the set

$$\frac{{f}_{8}}{{f}_{7}} .$$

If the parameters

$$\frac{h}{l} , \frac{{f}_{8}}{{f}_{7}}$$

are known, the Poisson's ratio of the material can be calculated by the formula (3).

The influence of damping

In any actual system, there are always various types of damping. In order to consider the influence of the damping energy-dissipation effect on the test results, modal damping ratio is introduced in a vibration system:

$${ζ}_{i} = \frac{c}{\sqrt{{k}_{i} {m}_{i}}} \approx \frac{ln \frac{x ( t )}{x ( t + {NT}_{d} )}}{2 N π} \qquad ( 6 )$$

The damping free vibration frequency of a vibration system in the presence of damping is:

$${\overline{ω}}_{i} = 2 π \overline{{f}_{i}} = \sqrt{1 - {ζ}_{i}^{2}} {ω}_{i} = \sqrt{1 - {ζ}_{i}^{2}} 2 π {f}_{i} \qquad ( 7 )$$

Considering the existence of damping, the formula (1) has the following relationship:

$$\frac{{\overline{f}}_{8}}{{\overline{f}}_{7}} = \sqrt{\frac{1 - {ζ}_{8}^{2}}{1 - {ζ}_{7}^{2}}} \frac{{f}_{8}}{{f}_{7}} = \sqrt{\frac{1 - {ζ}_{8}^{2}}{1 - {ζ}_{7}^{2}}} φ ( μ , 10 \frac{h}{l} ) \qquad ( 8 )$$

If the modal damping ξ₇,ξ₈ of the material can be obtained, a higher accuracy of mechanical parameter testing can be obtained. Usually, modal damping is related to the vibration mode of the structure, and the damping of local vibration modes is generally greater. ξ₇, ξ₈ correspond to the torsion vibration modes of the first-order and the second-order of the square specimen, both of which are external vibrations with similar damping coefficients and can be ignored.

### Square Plate Elasticity Testing Technique:

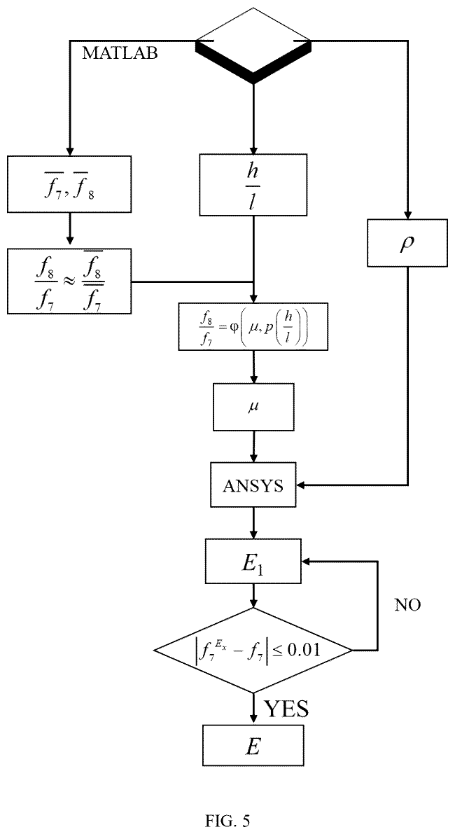

The testing method proposed in this embodiment is shown in FIG. 4, and its testing process is shown in FIG. 5. The testing steps are as follows:
1) Measuring the h, l and m of a square specimen;
2) Measuring the first-order torsional frequency f̅₇ and the second-order torsional frequency f̅₈ of the square specimen with a microphone;
3) Calculating its Poisson's ratio by the formula;

Substituting the Poisson's ratio and the density value of the material into ANSYS software to obtain its Young's modulus.

According to this embodiment, by constructing the relationship between the parameter set and the torsional frequency of the test specimen, the Poisson's ratio of the specimen is calculated using the homotopy ratio method, and the Poisson's ratio and the specimen density are substituted into ANSYS to calculate the Young's modulus, which effectively improves the convenience of the calculation and the calculation accuracy of the Poisson's ratio is further improved by taking into consideration the effect of the energy-dissipation effect of the damping on the test result in the process of the calculation of the Poisson's ratio.

### Embodiment 2

This embodiment proposes a testing method for Young's modulus and Poisson's ratio based on a square plate, including:

S1: Obtaining the height, the length, the density, and the quality information of the square plate specimen;

S2: Measuring the first-order torsional frequency and the second-order torsional frequency of the square plate specimen;

S3: Calculating Poisson's ratio based on the height, the length, the first-order torsional frequency, and the second-order torsional frequency of the square plate specimen;

S4: Calculating the Young's modulus of the square plate specimen based on the Poisson's ratio and the density.

As a preferred embodiment of the present application, in the S3, the calculation process of Poisson's ratio further includes:

S3.1: Calculating the frequency ratio between the first-order torsional frequency and the second-order torsional frequency;

S3.2: Constructing a relation function between the frequency ratio and the parameter set of the square plate specimen;

S3.3: Calculating the Poisson's ratio through homotopy method based on the relation function.

As a preferred embodiment of the present application, the relation function is as follows:

$$\frac{{f}_{8}}{{f}_{7}} = {ψ}_{\frac{8}{7}} ( μ , \frac{h}{l} )$$

wherein, f₈ is the second-order torsional frequency of the square plate specimen, f₇ is the first-order torsional frequency, h is the height, and l is the length.

As a preferred embodiment of the present application, the process of calculating the Poisson's ratio through homotopy method in the S3.3 further includes:

S3.3.1: introducing parameters into the relation function through homotopy method;

S3.3.2: obtaining the changing relationship between the parameter set and the frequency ratio, and calculating the Poisson's ratio based on the changing relationship.

The homotopy method has broad application prospects in fields such as material mechanics and structural engineering. The method is particularly important for dealing with complex material deformation problems and nonlinear relationships. In the calculation of Young's modulus, the homotopy method constructs a continuous function path to express the problem of the specimen material as a more easily solvable problem. Therefore, by changing the homotopy parameters, it can gradually transition from simple material deformation problems to more complex actual situations, thereby improving the accuracy of the calculation. At the same time, the homotopy method overcomes the problems of initial values, local convergence, and poor stability that may exist in traditional methods, making the calculation results more stable and reliable.

As a preferred embodiment of the present application, in the S3.3.1, the parameter introduced to the relation function through homotopy method are shown as follows:

$$p ( \frac{h}{l} ) = - 60.4107784498840 {( \frac{h}{l} )}^{2} + 163.263236949884 \frac{h}{l} - 0.0245424675384627$$

wherein, p is the homotopy parameter.

As a preferred embodiment of the present application, in the S3.3.2, the changing relationship between the parameter set and the frequency ratio is as follows:

$$φ ( μ , p ) = ( 1 - p ) {ψ}_{\frac{8}{7}} ( μ , 0.001 ) + p {ψ}_{\frac{8}{7}} ( μ , 0.1 )$$

wherein, p is the homotopy parameter.

It can be understood that in the calculation of the Young's modulus of the specimen, the influence of the damping of the specimen material cannot be ignored. Changes in damping capacity may cause the specimen to show different vibration behaviors when subjected to external forces, thereby affecting the measurement and calculation of the Young's modulus. When the material is subjected to external forces and produces vibration, damping will hinder the relative motion of the object and generate dissipative energy. This energy dissipation process may cause the material to show different mechanical properties during the elastic deformation stage, thereby affecting the measurement results of the Young's modulus. In addition, in the vibration environment, the damping of the specimen material will also affect the stress-strain relationship of the specimen, thereby affecting the calculation results of the Young's modulus.

Based on the above reasons, in the S3 of the embodiment, when calculating Poisson's ratio based on the height, the length, the first-order torsional frequency, and the second-order torsional frequency of the square plate specimen, it is necessary to consider the influence of damping energy-dissipation effect on the test results. Modal damping ratio is introduced into the vibration system to calculate the free vibration frequency of damping, so as to construct the relationship between damping and the relation function.

As a preferred embodiment of the present application, in the above process, the modal damping is as follows:

$${ζ}_{i} = \frac{c}{\sqrt{{k}_{i} {m}_{i}}} \approx \frac{ln \frac{x ( t )}{x ( t + {NT}_{d} )}}{2 N π}$$

Wherein, ξᵢ represents a modal damping, kᵢ and mᵢ respectively represent an element stiffness and an element quality, c represents damping coefficient, x(t) represents a damping vibration signal, N represents the number of periods, T_{d} represents the period of quasi-periodic motion in the presence of damping.

As a preferred embodiment of the present application, the free vibration frequency of damping is as follows:

$${\overline{ω}}_{i} = 2 π \overline{{f}_{i}} = \sqrt{1 - {ζ}_{i}^{2}} {ω}_{i} = \sqrt{1 - {ζ}_{i}^{2}} 2 π {f}_{i}$$

As a preferred embodiment of the present application, the relationship between the damping and the relation function is as follows:

$$\frac{{\overline{f}}_{8}}{{\overline{f}}_{7}} = \sqrt{\frac{1 - {ζ}_{8}^{2}}{1 - {ζ}_{7}^{2}}} \frac{{f}_{8}}{{f}_{7}} = \sqrt{\frac{1 - {ζ}_{8}^{2}}{1 - {ζ}_{7}^{2}}} φ ( μ , 10 \frac{h}{l} )$$

Wherein, ξ₇ and ξ₈ respectively represent the seventh-order modal damping and the eighth-order modal damping corresponding to f̅₇, f̅₈ of the square plate specimen.

As a preferred embodiment of the present application, the step S4, the process of calculating the Young's modulus of the square plate specimen based on the Poisson's ratio and the density further includes:

Substituting the calculated Poisson's ratio and the density value measured in the S1 into ANSYS software to calculate the Young's modulus of the square plate specimen.

Unless otherwise specified, all technical and scientific terms used in this article have the same meanings as those commonly understood by those skilled in the art of the present disclosure. Although the present disclosure only describes preferred methods and materials, any methods and materials similar or equivalent to those described herein may also be used in the implementation or testing of the present disclosure. All references mentioned in the specification are incorporated by reference to disclose and describe methods and/or materials related to the mentioned references. In the event of conflict with any incorporated literature, the contents of this specification shall prevail.

Finally, it should be noted that the above embodiments are only specific embodiments of the present disclosure, which is used to illustrate the technical solution of the present disclosure, not to limit it, and the scope of the present disclosure is not limited to this. Although the present disclosure has been described in detail with reference to the above embodiments, ordinary skilled persons in the art should understand that any skilled person familiar with the technical field can still conduct modifications or easily conceivable changes to the technical solutions described in the above embodiments, or equivalently replace some of the technical features within the technical scope disclosed in the present disclosure; and these modifications, changes, or substitutions do not depart from the essence and scope of the corresponding technical solutions of the embodiments of the present disclosure. All should be covered within the scope of the present disclosure. Therefore, the scope of the present disclosure should be based on the scope of the claims.

1. A testing method for Young's modulus and Poisson's ratio based on a square plate, wherein comprising the following steps:
obtaining a height, a length, a density, and a quality information of the square plate specimen;
measuring a first-order torsional frequency and a second-order torsional frequency of the square plate specimen;
obtaining a relationship between the first-order torsional frequency, the second-order torsional frequency, and an ideal first-order torsional frequency, an ideal second-order torsional frequency based on an influence of system damping;
calculating Poisson's ratio based on the height, the length, the first-order torsional frequency, and the second-order torsional frequency of the square plate specimen;
calculating a Young's modulus of the square plate specimen based on the Poisson's ratio and the density.

2. The testing method for Young's modulus and Poisson's ratio based on the square plate according to claim 1, wherein the relationship between the first-order torsional frequency, the second-order torsional frequency and the ideal first-order torsional frequency, and the ideal second-order torsional frequency is as follows:
$$\overline{{f}_{7}} = \sqrt{1 - {ζ}_{7}^{2}} {f}_{7} , \\ \overline{{f}_{8}} = \sqrt{1 - {ζ}_{8}^{2}} {f}_{8} ,$$
in the formula, ξ₇ and ξ₈ represent a modal damping ratio; f₇ is the first-order torsional frequency, f₈ is the second-order torsional frequency, and f̅₇ and f̅₈ are the ideal first-order torsional frequency and the ideal second-order torsional frequency, respectively.

3. The testing method for Young's modulus and Poisson's ratio based on the square plate according to claim 1, wherein a calculation process of Poisson's ratio comprises:
calculating a frequency ratio between the first-order torsional frequency and the second-order torsional frequency;
calculating a thickness-length ratio of the square plate specimen;
constructing a continuous function relationship between the frequency ratio and the Poisson's ratio of the square plate specimen;
calculating the Poisson's ratio through homotopy method based on the continuous function relationship.

4. The testing method for Young's modulus and Poisson's ratio based on the square plate according to claim 3, wherein the continuous function relationship is as follows:
$$\frac{{f}_{8}}{{f}_{7}} = {ψ}_{\frac{8}{7}} ( μ , \frac{h}{l} )$$
wherein, f₈ is the second-order torsional frequency of the square plate specimen, f₇ is the first-order torsional frequency, h is the height, and l is the length.

5. The testing method for Young's modulus and Poisson's ratio based on the square plate according to claim 4, when the thickness-length ratio is fixed at 0.001 and 0.1, the continuous function relationship is:
$${ψ}_{\frac{8}{7}} ( μ , 0.001 ) = 0.0303331630728725 {μ}^{2} + 0.12783046900851 μ + 1.41427221610838 ; \\ {ψ}_{\frac{8}{7}} ( μ , 0.1 ) = 0.0101932160287526 {μ}^{2} + 0.162230099055876 μ + 1.44015288291539 .$$

6. The testing method for Young's modulus and Poisson's ratio based on the square plate according to claim 3, wherein the calculation process of the Poisson's ratio through homotopy method comprises:
introducing a parameter into the continuous function relationship through homotopy method, constructing a continuous function relationship between the frequency ratio and the thickness-length ratio and the Poisson's ratio of the square plate specimen, and calculating Poisson's ratios of different isotropic materials based on the continuous function relationship.

7. The testing method for Young's modulus and Poisson's ratio based on the square plate according to claim 3, wherein the parameter introduced to the continuous function relationship through homotopy method is shown in the following formula:
$$p ( \frac{h}{l} ) = - 59.6865121095568 {( \frac{h}{l} )}^{2} + 16.2937683627739 \frac{h}{l} - 0.0288130972097893 .$$

8. The testing method for Young's modulus and Poisson's ratio based on the square plate according to claim 2, wherein a calculation of the Poisson's ratio is as follows:
$$\frac{{\overline{f}}_{8}}{{\overline{f}}_{7}} == \sqrt{\frac{1 - {ζ}_{8}^{2}}{1 - {ζ}_{7}^{2}}} φ ( μ , p ) ,$$
wherein, ξ₇ and ξ₇ respectively represent a seventh-order modal damping and an eighth-order modal damping corresponding to f̅₇, f̅₈ of the square plate specimen.

9. The testing method for Young's modulus and Poisson's ratio based on the square plate according to claim 3, wherein the continuous function relationship is as follows:
$$φ ( μ , p ) = ( 1 - p ) + p {ψ}_{\frac{8}{7}} ( μ , 0.1 )$$
wherein, p is an introduced homotopy parameter.

10. The testing method for Young's modulus and Poisson's ratio based on the square plate according to claim 1, wherein the modal damping is as follows:
$${ζ}_{i} = \frac{c}{\sqrt{{k}_{i} {m}_{i}}} \approx \frac{ln \frac{x ( t )}{x ( t + {NT}_{d} )}}{2 N π}$$
wherein, ξᵢ represents a modal damping, kᵢ and mᵢ respectively represent an element stiffness and an element quality, c represents a damping coefficient, x(t) represents a damping vibration signal, N represents the number of periods, T_{d} represents a period of quasi-periodic motion in a presence of damping.
